(19) United States
(12) Patent Application Publication
(10) Pub. No.: US 2014/0125776 A1
(43) Pub. Date: May 8, 2014

(54) 3D PATHOLOGY SLIDE SCANNER

(71) Applicant: Huron Technologies International Inc,, Waterloo (CA)

(72) Inventors: Savvas Damaskinos, Kitchener (CA); Ian James Craig, Kitchener (CA); Arthur Edward Dixon, Waterloo (CA)

(21) Appl. No.: 14/122,195

(22) PCT Filed: May 25, 2012
(86) PCT No.: PCT/CA2012/000499

§ 371 Date: Nov. 25, 2013

Related U.S. Application Data
(60) Provisional application No. 61/490,041, filed on May 25, 2011.

(51) Int. Cl. G02B 21/36; G01N 21/59; G01N 21/47; G01N 21/64

(52) U.S. Cl. CPC G02B 21/365; G01N 21/64; G01N 21/59; G01N 21/47
USPC 348/50

(57) ABSTRACT

An instrument and method for scanning a large specimen comprises a specimen holder to support the specimen, an optical system to focus an image of a series of parallel object planes onto one of a two dimensional detector array, multiple linear arrays, multiple TDI arrays and multiple two-dimensional arrays. The detector array has a detector image plane that is tilted relative to the series of object planes in a scanned direction to enable a series of image frames of the specimen to be obtained in order to produce a three-dimensional image of at least part of the specimen with data from each row of the image frame representing a different plane in the three-dimensional image.

### BACKGROUND OF THE INVENTION

1. Field of the Invention

This invention relates to the field of microscopic imaging of large specimens with particular emphasis on brightfield and fluorescence imaging. Applications include imaging tissue specimens, genetic microarrays, protein arrays, tissue arrays, cells and cell populations, biochips, arrays of biomolecules, detection of nanoparticles, photoluminescence imaging of semiconductor materials and devices, and many others.

2. Description of the Prior Art

The macroscope originally described in U.S. Pat. No. 5,381,224 is a scanning-laser system that uses a telecentric laser-scan lens to provide a wide field of view. Several embodiments are presently in use. These include instruments for fluorescence and photoluminescence (including spectrally-resolved) imaging (several other contrast mechanisms are also possible), instruments in which a raster scan is provided by the combination of a scanning mirror and a scanning specimen stage, instruments in which the specimen stage is stationary and the raster scan is provided by two scanning mirrors rotating about perpendicular axes, confocal and non-confocal versions, and other embodiments. A macroscope with fine focus adjustment is described in U.S. Pat. No. 7,218,446, and versions for reflected-light, fluorescence, photoluminescence, multi-photon fluorescence, transmitted-light, and brightfield imaging were described. The combination of a scanning laser macroscope with a scanning laser microscope to provide an imaging system with a wide field of view and the high resolution capability of a microscope is described in U.S. Pat. No. 5,532,873.

When the macroscope is used for fluorescence imaging, it has several advantages. Exposure for each fluorophore can be adjusted separately without changing scan speed by changing either laser intensity and/or detector gain (in the case of a detector comprised of a photomultiplier tube (pmt) followed by a preamplifier, both the pmt voltage (which changes pmt gain) and preamplifier gain can be changed). The ability to adjust the detection gain for each fluorophore separately allows the instrument to simultaneously collect multiple fluorophore images that are all correctly exposed. In addition, the appropriate laser wavelength can be provided to excite a chosen fluorophore, and excitation wavelengths can be chosen so they do not overlap detection wavelength ranges.

Several other technologies are used for imaging large specimens at high resolution. With tiling microscopes, the image of a small area of the specimen is recorded with a digital camera (usually a CCD camera), the specimen is moved with a computer-controlled microscope stage to image an adjacent area, an image of the adjacent area is recorded, the stage is moved again to the next area, and so on until a number of image tiles have been recorded that together cover the whole area of the specimen. Images of each area (image tiles) are recorded when the stage is stationary, after waiting long enough for vibrations from the moving stage to dissipate, and using an exposure time that is sufficient to record the fluorescence images. These image tiles can be butted together, or overlapped and stitched using computer stitching algorithms, to form one image of the entire specimen. Such images may contain tiling artifacts, caused by focus changes between adjacent tiles, differences in illumination intensity across the field of view of the microscope, barrel or pincushion distortion near the edge of the tiles, and microscope objectives that do not have a flat focal plane. For large specimens, thousands of tiles may be required to image the entire specimen, increasing the chance of tiling artifacts. Tiling microscopes are very slow for fluorescence imaging.

When tiling microscopes are used for fluorescence imaging, the areas surrounding each tile and the overlapping edges of adjacent tiles are exposed twice (and the corners four times) which can bleach some fluorophores. Exposure is adjusted by changing the exposure time for each tile. If multiple fluorophores are imaged, a different exposure time is required for each, so each fluorophore requires a separate image at each tile position. Multiple exposure of the specimen for imaging multiple fluorophores can also increase bleaching. After all tiles have been collected, considerable effort (both human and computer) is required to stitch the tiles together and correct each tile for illumination intensity and collection sensitivity changes across the field of view of the microscope (correction for variations in illumination intensity and collection sensitivity is sometimes called “field flattening”). Stitching tiles together is also complicated by distortion and curvature of field of the microscope objective, which occur near the edges of the field of view (just where stitching of tiles occurs).

Strip scanning instruments are also used for imaging large specimens. In these instruments infinity-corrected microscope optics are used, with a high Numerical Aperture (high NA) microscope objective and a tube lens of the appropriate focal length to focus an image of the specimen directly on a CCD or CMOS linear array sensor or TDI sensor with the correct magnification to match the resolution of the microscope objective with the detector pixel size for maximum magnification in the digitized image {as described in “Choosing Objective Lenses: The Importance of Numerical Aperture and Magnification in Digital Optical Microscopy”, David W. Piston, Biol. Bull. 195, 1-4 (1998)}. A linear CCD detector array with 1000 or 2000 pixels is often used, and three separate linear detectors with appropriate filters to pass red, green and blue light are used for RGB brightfield imaging. The sample is moved at constant speed in the direction perpendicular to the long dimension of the linear detector array to scan a narrow strip across a microscope slide. The entire slide can be imaged by imaging repeated strips and butting them together to create the final image. Another version of this technology uses TDI (Time Delay and Integration) array sensors which increase both sensitivity and imaging speed. In both of these instruments, exposure is varied by changing illumination intensity and/or scan speed.

Such a microscope is shown in FIG. 1 (Prior Art). A tissue specimen 100 (or other specimen to be imaged) mounted on microscope slide 101 is illuminated from below by illumination source 110. Light passing through the specimen is collected by infinity-corrected microscope objective 115 which is focused on the specimen by piezo positioner 120. The microscope objective 115 and tube lens 125 form a real image of the specimen on linear detector array 130. An image of the specimen is collected by moving the microscope slide at constant speed using motorized stage 105 in a direction perpendicular to the long dimension of the detector array 130, combining a sequence of equally-spaced line images from the array to construct an image of one strip across the specimen. Strips are then assembled to form a complete image of the specimen.

For brightfield imaging, most strip-scanning instruments illuminate the specimen from below, and detect the image in transmission using a sensor placed above the specimen. In brightfield, signal strength is high, and red, green and blue channels are often detected simultaneously with separate linear detector arrays to produce a colour image.

Compared to brightfield imaging, fluorescence signals can be thousands of times weaker, and some fluorophores have much weaker emission than others. Fluorescence microscopy is usually performed using illumination from the same side as detection (epifluorescence) so that the bright illumination light passing through the specimen does not enter the detector. In strip-scanning instruments, exposure is varied by changing scan speed, so present strip-scanning instruments scan each fluorophore separately, reducing the scan speed when greater exposure is required for a weak fluorophore. Since exposure is adjusted by changing scan speed, it is difficult to design a strip-scanner for simultaneous imaging of multiple fluorophores, where each channel would have the same exposure time, and present strip-scanners scan one fluorophore at-a-time. In addition, in fluorescence microscopy, relative intensity measurements are sometimes important for quantitative measurement, and 12 or 16 bit dynamic range may be required. For present strip scanners, this would require larger dynamic range detectors and slower scan speeds.

Before scanning a large specimen in fluorescence, it is important to set the exposure time (in a tiling or strip-scanning microscope) or the combination of laser intensity, detector gain and scan speed (in a scanning laser macroscope or microscope) so that the final image will be properly exposed—in general it should not contain saturated pixels, but the gain should be high enough that the full dynamic range will be used for detecting each fluorophore in the final image. Two problems must be solved to achieve this result—the exposure must be estimated in advance for each fluorophore, and for simultaneous detection of multiple fluorophores the exposure time must be estimated and scan speed set separately for each detection channel before scanning. For strip-scanning instruments, estimating the exposure in advance is difficult without scanning the whole specimen first to check exposure, and this must be done for each fluorophore. Instead of scanning first to set exposure, many operators simply set the scan speed to underexpose slightly, with resulting noisy images, or possibly images with some overexposed (saturated) areas if the estimated exposure was not correct. For macroscope-based instruments, a high-speed preview scan can be used to set detection gain in each channel before final simultaneous imaging of multiple fluorophores (see WO2009/137935 A1, “Imaging System with Dynamic Range Maximization”).

A prior art scanning microscope for fluorescence imaging is shown in FIG. 2. A tissue specimen 100 (or other specimen to be imaged) mounted on microscope slide 101 is illuminated from above by illumination source 200. In fluorescence imaging, the illumination source is usually mounted above the specimen (epifluorescence) so that the intense illumination light that passes through the specimen is not mixed with the weaker fluorescence emission from the specimen, as it would be if the illumination source were below the specimen. Several different optical combinations can be used for epifluorescence illumination—including illumination light that is injected into the microscope tube between the microscope objective and the tube lens, using a dichroic beamsplitter to reflect it down through the microscope objective and onto the specimen. In addition, a narrow wavelength band for the illumination light is chosen to match the absorption peak of the fluorophore in use. Fluorescence emitted by the specimen is collected by infinity-corrected microscope objective 115, which is focused on the specimen by piezo positioner 120. Emission filter 205 is chosen to reject light at the illumination wavelength and to pass the emission band of the fluorophore in use. The microscope objective 115 and tube lens 125 form a real image of the specimen on TDI detector array 210. An image of the specimen is collected by moving the microscope slide at constant speed using motorized stage 105 in a direction perpendicular to the long dimension of the detector array 210, combining a sequence of equally-spaced, time-integrated line images from the array to construct an image of one strip across the specimen. Strips are then assembled to form a complete image of the specimen. When a CCD-based TDI array is used, each line image stored in memory is the result of integrating the charge generated in all of the previous lines of the array while the scan proceeds, and thus has both increased signal/noise and amplitude (due to increased exposure time) when compared to the result from a linear array detector. Exposure is also increased by reducing scan speed, so the scan time (and thus image acquisition time) is increased when using weak fluorophores. It is difficult to predict the best exposure time before scanning. When multiple fluorophores are used on the same specimen, the usual imaging method is to choose illumination wavelengths to match one fluorophore, select the appropriate emission filter and scan time (speed) for the chosen fluorophore, and scan one strip in the image. Then the illumination wavelength band is adjusted to match the absorption band of the second fluorophore, a matching emission filter and scan speed are chosen, and that strip is scanned again. Additional fluorophores require the same steps to be repeated. Finally, this is repeated for all strips in the final image. Some instruments use multiple TDI detector arrays to expose and scan multiple fluorophores simultaneously, but this usually results in a final image where one fluorophore is exposed correctly and the others are either under- or over-exposed. Exposure can be adjusted by changing the relative intensity of the excitation illumination for each fluorophore, which should be easy to do if LED illumination is used. When multiple illumination bands are used at the same time, the resulting image for each fluorophore may differ from that produced when only one illumination band is used at a time because of overlap of the multiple fluorophore excitation and emission bands, and because autofluorescence from the tissue itself may be excited by one of the illumination bands. Autofluorescence emission usually covers a wide spectrum and may cause a bright background in all of the images when multiple fluorophores are illuminated and imaged simultaneously.

A description of strip scanning instruments, using either linear arrays or TDI arrays, is given in U.S. Patent Application Publication No. US2009/0141126 A1 (“Fully Automatic Rapid Microscope Slide Scanner”, by Dirk Soenksen).

Linear arrays work well for brightfield imaging, but the user is often required to perform a focus measurement at several places on the specimen before scanning, or a separate detector is used for automatic focus. Linear arrays are not often used for fluorescence imaging because exposure time is inversely proportional to scan speed, which makes the scan time very long for weak fluorophores. In addition, exposure (scan speed) must be adjusted for each fluorophore, making simultaneous measurement of multiple fluorophores difficult when they have widely different fluorescence intensity (which is common).

TDI arrays and associated electronics are expensive, but the on-chip integration of several exposures of the same line on the specimen provides the increased exposure time required for fluorescence imaging while maintaining a reasonable scan speed. Simultaneous imaging of multiple fluorophores using multiple TDI detector arrays is still very difficult however, since each of the detectors has the same integration time (set by the scan speed), so it is common to use only one TDI array, adjusting exposure for each fluorophore by changing the scan speed and collecting a separate image for each fluorophore. Focus is set before scanning at several positions on the specimen, or automatic focus is achieved using a separate detector or focus measuring device.

All of the prior-art scanners require dynamic focus while scanning, with focus adjustment directed by pre-scan focus measurements at several positions along each image strip, or by using a separate focus detector. In addition, none of the prior-art scanners described above acquires a three-dimensional image of the specimen.

### DEFINITIONS

For the purposes of this patent document, a “macroscopic specimen” (or “large microscope specimen”) is defined as one that is larger than the field of view of a compound optical microscope containing a microscope objective that has the same Numerical Aperture (NA) as that of the scanner described in this document.

For the purposes of this patent document, TDI or Time Delay and Integration is defined as the method and detectors used for scanning moving objects consisting of a CCD- or CMOS-based TDI detector array and associated electronics. In a CCD-based TDI array charge is transferred from one row of pixels in the detector array to the next in synchronism with the motion of the real image of the moving object. As the object moves, charge builds up and the result is charge integration just as if a longer exposure were used to image a stationary object. When an object position in the moving real image (and integrated charge) reaches the last row of the array, that line of pixels is read out. In operation the image of the moving specimen is acquired one row at a time by sequentially reading out the last line of pixels on the detector. This line of pixels contains the sum of charge transferred from all previous lines of pixels collected in synchronism with the image moving across the detector. One example of such a camera is the DALSA Piranha TDI camera. In a CMOS-based TDI detector, voltage signals are transferred instead of charge.

For the purposes of this patent document, a frame grabber is any electronic device that captures individual, digital still frames from an analog video signal or a digital video stream or digital camera. It is often employed as a component of a computer vision system, in which video frames are captured in digital form and then displayed, stored or transmitted in raw or compressed digital form. This definition includes direct camera connections via USB, Ethernet, IEEE 1394 (“FireWire”) and other interfaces that are now practical.

For the purposes of this patent document, “depth of focus” of a microscope is defined as the range the image plane can be moved while acceptable focus is maintained, and “depth of field” is the thickness of the specimen that is sharp at a given focus level. “Depth of focus” pertains to the image space, and “depth of field” pertains to the object (or specimen) space.

For the purposes of this patent document, “fluorescence” includes photoluminescence; and “specimen” includes but is not limited to tissue specimens, genetic microarrays, protein arrays, tissue arrays, cells and cell populations, biochips, arrays of biomolecules, plant and animal material, insects and semiconductor materials and devices. Specimens may be mounted on or contained in any kind of specimen holder.

The “scan plane” is a plane perpendicular to the optical axis of the instrument in which the specimen moves relative to the optical axis. When the specimen is mounted on a microscope slide, the scan plane is parallel to the surface of the microscope slide.

### OBJECTS OF THE INVENTION

1. It is an object of this invention to provide a method of scanning a large microscope specimen on a glass microscope slide (or other specimen holder) using a two-dimensional detector array that is tilted in the scan direction (the usual orientation for such a detector array is perpendicular to the optical axis of the instrument and parallel to the microscope slide) such that a series of image frames tilted with respect to the surface of microscope slide are acquired as the stage scans, where data from each row of pixels in the detector produces one plane of a three-dimensional image of the specimen, which may include the entire thickness of the specimen in the case of thin specimens. Optical tilt of the detector with respect to the lens can also be achieved by putting a glass wedge in front of the detector, with the sharp angle in the scan direction (or the opposite direction).
2. It is an object of this invention to provide a method and instrument for scanning a specimen on a microscope slide (or other specimen holder) in which a series of planes are imaged at different depths in the specimen (perhaps including the entire thickness of the specimen and a thin layer above and below the specimen). During (or after) scanning, an in-focus two-dimensional image of the entire specimen (or image strip, when the specimen is too large to be imaged in a single strip) is calculated and displayed. No mechanical focus adjustments are required either before or during scanning.
3. It is an object of this invention to provide an instrument and method of scanning large microscope specimens on a moving microscope stage in which the leading rows of detector pixels (in a detector tilted in the scan direction) detect the height (position) of the surface of the microscope slide and produce feedback to actuate a focus mechanism to keep subsequent rows of the detector focused at a fixed distance above the top of the microscope slide (but inside the specimen).
4. It is an object of this invention to provide a microscope slide scanner and method for acquiring a stack of image planes using a two-dimensional detector array tilted in the scan direction, such image stack being used with computer-based deconvolution of the scanner's point spread function to provide increased resolution, especially for fluorescence.
5. It is an object of this invention to provide a microscope slide scanner and method for acquiring a stack of image planes using a two-dimensional detector array tilted in the scan direction such that each row in the array images a different plane in the specimen, resulting in a three-dimensional image comprised of a stack of image planes, and software that enables the user to change the focus plane being viewed by moving up and down in the image stack.
6. It is an object of this invention to provide a microscope slide scanner and method for acquiring a stack of image planes using a two-dimensional detector array tilted in the scan direction such that each row in the array images a different plane in the specimen, resulting in a three-dimensional image comprised of a stack of image planes, and viewing software that enables the user to produce a maximum-intensity projection image of the specimen, and a companion file containing the depth information of the maximum intensity pixels in the maximum-intensity projection image.
7. It is an object of this invention to provide a microscope slide scanner and method for acquiring a stack of image planes using a two-dimensional detector array tilted in the scan direction such that each row in the array images a different plane in the specimen, resulting in a three-dimensional image comprised of a stack of image planes, and software that enables the user to produce a maximum-spatial-frequency projection image and a companion file containing the depth information of the maximum-spatial-frequency pixels in the maximum-spatial-frequency projection image.
8. It is an object of this invention to provide a microscope slide scanner and method for acquiring a stack of image planes using a two-dimensional detector array tilted in the scan direction such that each row in the array images a different plane in the specimen, resulting in a three-dimensional image comprised of a stack of image planes, and software that enables the user to produce three maximum-spatial-frequency projection images in each of the X, Y and Z image planes, where the scan direction is the Y direction, and the vertical (focus) direction is the Z direction, and three companion image files containing the position information of the pixels in the three maximum-spatial-frequency projection images.
9. It is an object of this invention to provide a microscope slide scanner and method for acquiring a stack of image planes using a two-dimensional detector array tilted in the scan direction such that each row in the array images a different plane in the specimen, resulting in a three-dimensional image comprised of a stack of image planes, and software that enables the user to apply pattern-recognition algorithms to the three-dimensional image stack to identify regions of interest and for use in computer-aided diagnosis.
10. It is an object of this invention to provide a microscope slide scanner and method for acquiring a stack of image planes using multiple linear arrays positioned on an image plane tilted in the scan direction such that each linear array images a different plane in the specimen, resulting in a three-dimensional image comprised of a stack of image planes.
11. It is an object of this invention to provide a microscope slide scanner and method for acquiring a stack of image planes using multiple TDI arrays positioned on an image plane tilted in the scan direction such that each TDI array images a different plane in the specimen, resulting in a three-dimensional image comprised of a stack of image planes. In this embodiment the TDI arrays themselves are not tilted with respect to the specimen plane (the plane of the microscope slide).
12. It is an object of this invention to provide a microscope slide scanner and method for acquiring a stack of image planes using three (or more) two-dimensional arrays (e.g. 4000×16 pixels each) placed on a tilted image plane (but not tilted themselves) and Moving Specimen Image Averaging (as defined earlier in this document) to image three (or more) planes in the specimen in fluorescence.

### SUMMARY OF THE INVENTION

An instrument for scanning a large specimen comprises a specimen holder to support the specimen, an optical system to focus an image of a series of parallel object planes in the specimen onto a two dimensional detector array. The detector array has a detector image plane, the detector image plane being tilted relative to the series of object planes in a scan direction to enable a series of image frames of the specimen to be obtained during a scan as the specimen moves relative to an optical axis of the instrument in a scan plane. Data from each row of the image frame represents a different plane in a three-dimensional image of at least part of the specimen comprised of a stack of image planes. The detector array is mounted to tilt about an axis that is parallel to rows of pixels in the detector array.

An instrument for scanning a large specimen, comprises a specimen holder to support the specimen, the specimen having a series of parallel object planes. The instrument has an optical system to focus an image from each object plane onto multiple linear arrays positioned on a detector image plane tilted in a scan direction such that data from each linear array comprises a different plane in a three-dimensional image of at least part of the specimen comprised of a stack of image planes. The multiple linear arrays are not tilted but are located on the image plane that is tilted relative to a scan plane and relative to the series of object planes in the specimen to enable a series of image frames of the specimen to be obtained during the scan as the specimen moves relative to an optical axis of the instrument in the scan plane.

An instrument for scanning a large specimen comprises a specimen holder to support the specimen, the specimen having a series of parallel object planes. The instrument has an optical system to focus an image from each object plane of the specimen onto multiple TDI arrays positioned on a detector image plane tilted in a scan direction such that data from each TDI array comprises a different plane in a three dimensional image of at least part of the specimen comprised of a stack of image planes. The multiple TDI arrays are not tilted with respect to a scan plane but are located on an image plane that is tilted relative to the scan plane, each TDI array producing a different plane in the stack of image planes, the specimen moving relative to an optical axis of the instrument in the scan plane during a scan.

An instrument for scanning a large specimen comprises a specimen holder to support the specimen, the specimen having a series of parallel object planes. The instrument has an optical system to focus images of the specimen onto multiple two-dimensional arrays positioned on a detector image plane tilted in a scan direction such that data from each two-dimensional array comprises a different plane in a three-dimensional image of at least part of the specimen comprised of a stack of image planes. The multiple two-dimensional arrays are not tilted with respect to a scan plane but are located on the detector image plane that is tilted relative to the scan plane, the specimen moving relative to an optical axis of the instrument in the scan plane during a scan. There is a computer to receive, process and display the three dimensional image.

A method for scanning a large specimen uses an instrument having a specimen holder to support the specimen, the specimen having a series of parallel object planes. This instrument has an optical system to focus an image from each object plane of the specimen onto a two-dimensional detector array, the detector array having a detector image plane, the specimen being movable relative to the optical system. The method comprises optically tilting the detector image plane relative to the series of object planes in a scan direction, taking a series of image frames of the specimen during the scan, the image frames being tilted relative to a scan plane, moving the specimen relative to an optical axis of the instrument in the scan plane during a scan, and assembling the image frames to form a three dimension image of at least part of the specimen.

A method for scanning a large specimen uses an instrument having a specimen holder to support the specimen, the specimen having a series of parallel object planes. The instrument has an optical system to focus an image from each object plane of the specimen onto multiple linear arrays positioned on a detector image plane tilted in a scan direction, the specimen being movable relative to the optical system. The method comprises positioning the multiple linear arrays on an image plane tilted in the scan direction such that each linear array images a different plane in the specimen resulting in a three dimensional image comprised of a stack of image planes.

A method for scanning a large specimen uses an instrument having a specimen holder to support to specimen, the specimen having a series of parallel object planes that are also parallel to the scan plane. The instrument has an optical system to focus an image from each object plane of the specimen onto multiple TDI arrays that are parallel to the scan plane but positioned on a detector image plane tilted in a scan direction. The method comprises having each TDI array image a different plane in the specimen resulting in a three dimensional image comprised of a stack of image planes.

A method for scanning a large specimen uses an instrument having a specimen holder to support the specimen, the specimen having a series of parallel object planes that are parallel to the scan plane. The instrument has an optical system to focus an image from each object plane of the specimen onto a plurality of two dimensional arrays. The method comprises placing the two dimensional arrays that are parallel to the scan plane on a tilted image plane and using moving specimen image averaging to image the plurality of planes resulting in a three dimensional image comprised of a stack of image planes of at least part of the specimen in fluorescence.

### BRIEF DESCRIPTION OF THE DRAWINGS

FIG. 1 is a schematic view of a prior-art brightfield microscope slide scanner using a linear detector array;

FIG. 2 is a schematic view of a prior-art fluorescence microscope slide scanner using a TDI detector array;

FIG. 3 shows a 256×4000 pixel detector array (top) and the motion of the field-of-view of the array as the stage moves the specimen during scan;

FIG. 4A shows a slide scanner using a tilted two-dimensional detector array which results in an object plane tilted in the scan direction;

FIG. 4B shows a slide scanner using a glass wedge to focus a real image on a two-dimensional detector array that is perpendicular to the instrument axis but the incoming rays seem to converge to a virtual image frame on a tilted image plane;

FIG. 5 shows a slide scanner in which a tilted object plane is caused by tilting the imaging lens;

FIG. 6 shows a slide scanner for brightfield imaging with an infinity-corrected microscope objective and a tube lens in which a two-dimensional detector array is tilted to provide an object plane tilted in the scan direction;

FIG. 7 shows a slide scanner for fluorescence imaging with an infinity-corrected microscope objective and a tube lens in which a two-dimensional detector array is tilted to provide an object plane tilted in the scan direction;

FIG. 8 shows a slide scanner for fluorescence or brightfield imaging containing three separate detection arms for detecting three different fluorophores simultaneously or for detecting RGB brightfield images;

FIG. 9 shows a slide scanner for brightfield imaging in which multiple linear detectors are located on a tilted image plane;

FIG. 10 shows a slide scanner for fluorescence imaging using multiple 2D detector arrays (TDI arrays, or 2D detector arrays for MSIA imaging) located on a tilted image plane (but the detector arrays are not tilted with respect to the scan plane);

FIG. 11 illustrates how a digital 3D image stack of one strip across the specimen is produced by the scanners described in FIGS. 4, 5, 6 and 7; and

FIG. 12 illustrates how a three layer digital image stack of one strip across the specimen is produced by the scanners described in FIGS. 9 and 10.

### DESCRIPTION OF THE INVENTION

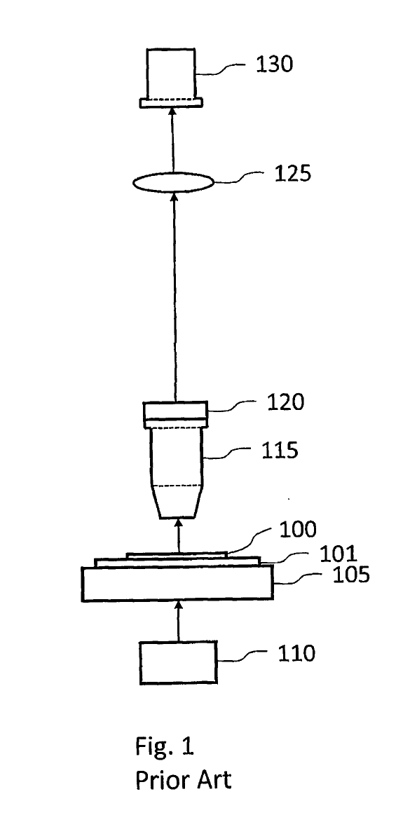

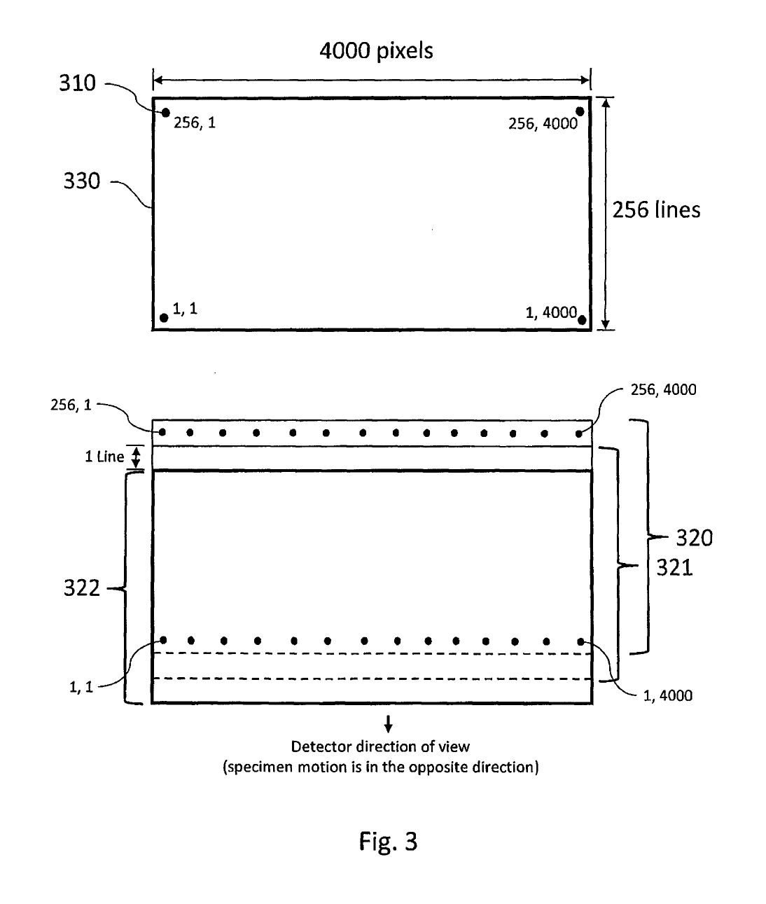

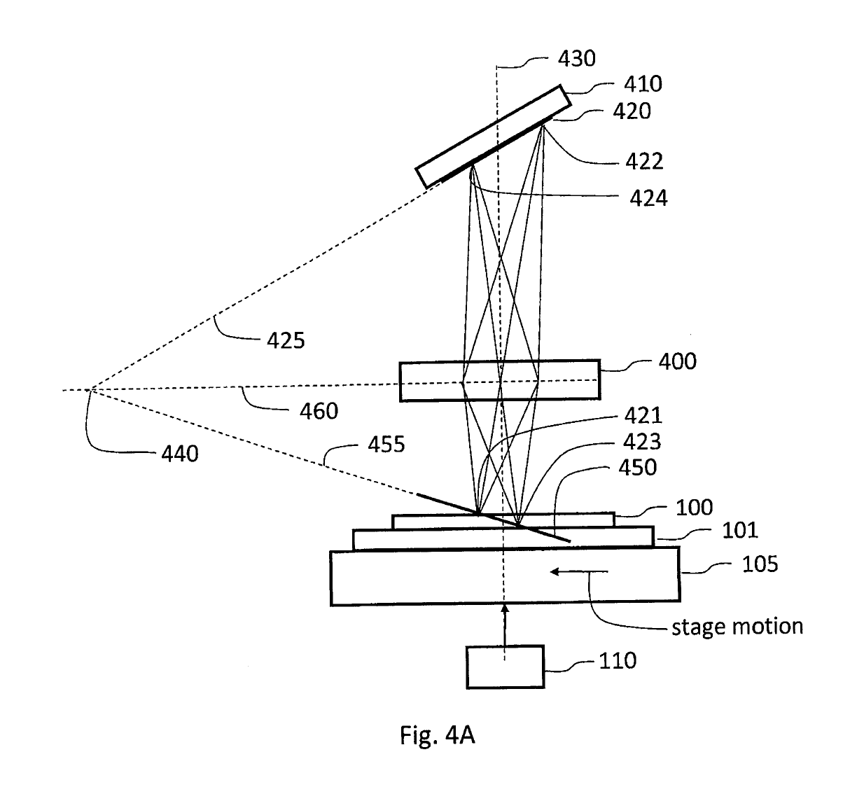

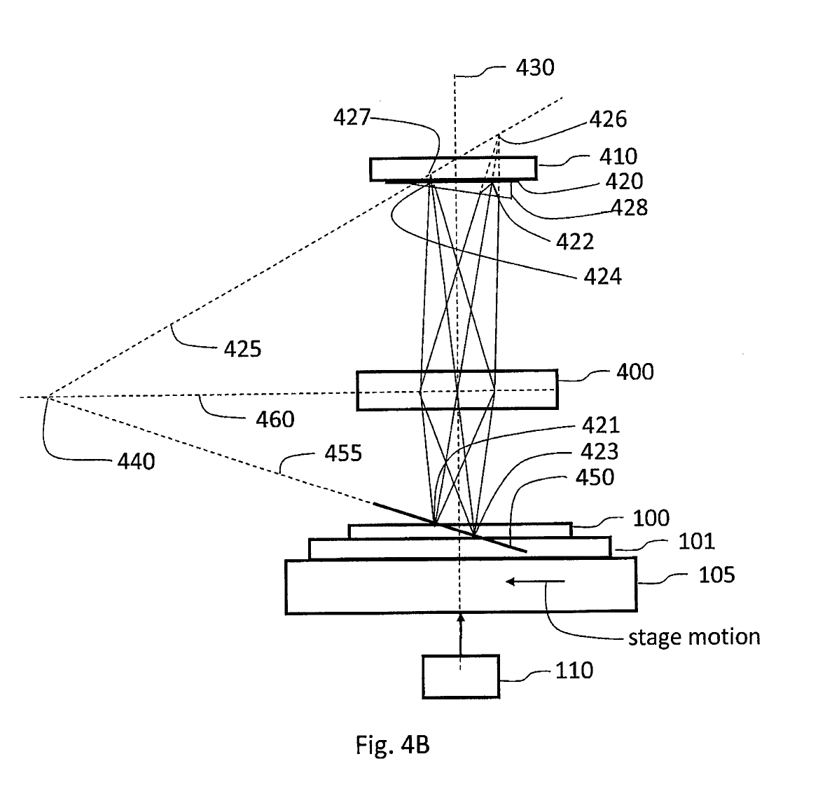

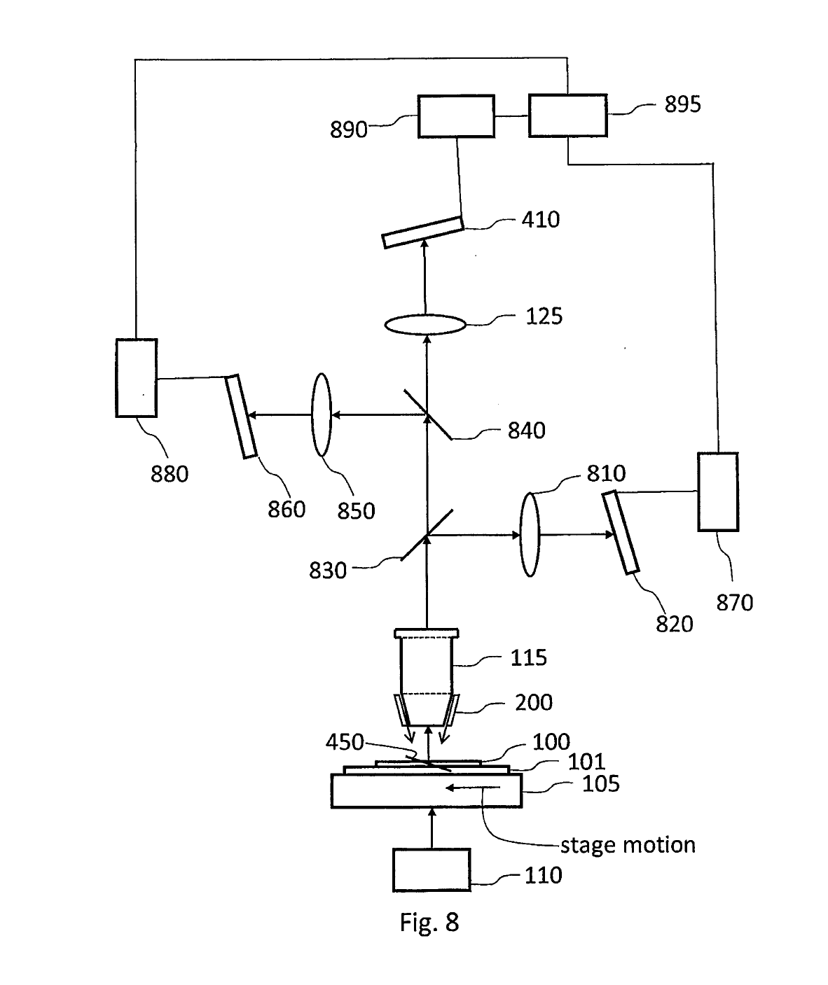

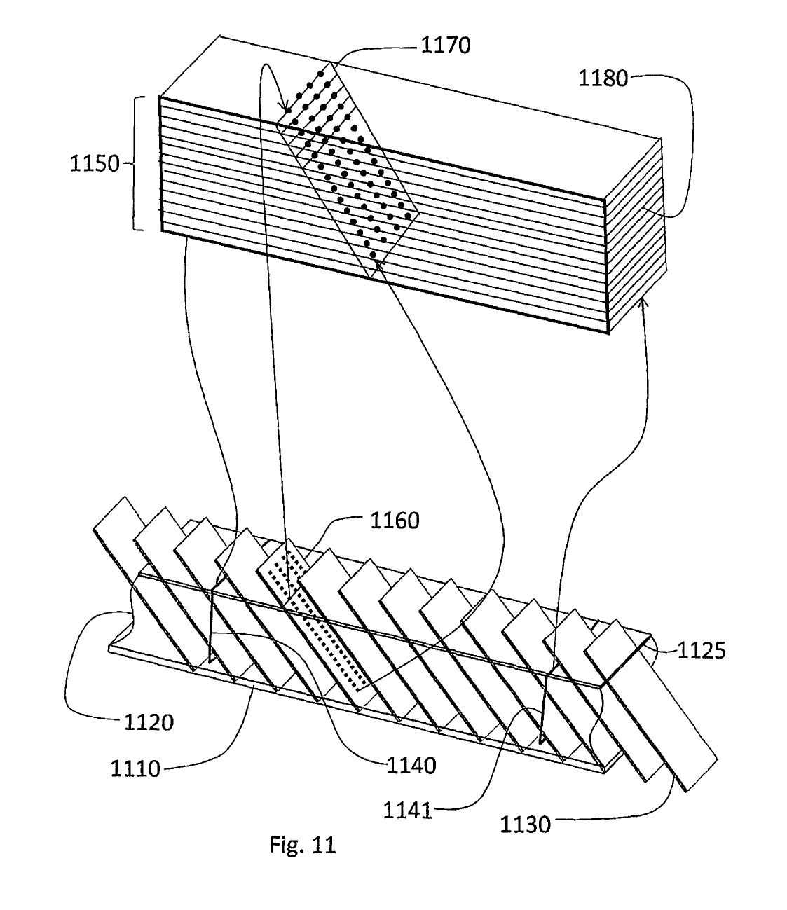

An instrument and method for scanning microscope slides using a CCD or CMOS two-dimensional detector array that adds intermediate image frames acquired every time the microscope slide has moved an incremental distance equal to that between rows of pixels in the final image has been described in U.S. Patent Application Ser. No. 61/427,153, “Pathology Slide Scanner”, by A. E. Dixon. The instrument described in that application (which has not been published) has all of the advantages of a slide scanner that uses a TDI array, but uses inexpensive two-dimensional arrays instead. In addition, since the final image is the sum of a large number of intermediate image frames, each intermediate frame being displaced a distance equal to the distance between rows of pixels in the final image, it can have a larger dynamic range than that supported by the detector array, and this increased dynamic range enables multiple fluorophores to be imaged simultaneously using separate detector arrays for each fluorophore, with adjustment for the emission strength (brightness of the image from each fluorophore) after scan is complete. Each line in the final image is the result of adding several exposures of the same line using sequential adjacent lines of pixels in the detector array and then dividing by the number of exposures, or adding the data from each exposure to a data set with a larger dynamic range. For example, one could add 256 images from an 8-bit detector into a 16-bit image store. FIG. 3 shows a 256×4000 pixel detector array 330 (top) and the motion of the field-of-view of the array as the stage moves the specimen during scan (bottom). During scan, intermediate image 320 is stored in the image store, then after the specimen has moved a distance equal to the distance between rows of pixels in the final image, intermediate image 321 is added to data in the image store, shifted by one row of pixels, followed by intermediate image 322, and so on. Using the array shown in FIG. 3, each pixel in the final strip image stored in the imaging computer is the sum of 256 exposures of the same pixel position in the specimen. In this particular example, if the frame grabber produces 8-bit images, the resulting stored image has a dynamic range of 16 bits (each pixel is made up of a sum of 256 exposures where each exposure has a maximum value of 255). This technique is called Moving Specimen Image Averaging (MSIA), and for the purposes of this patent document, this is the definition of Moving Specimen Image Averaging. The fluorescence image of the specimen strip being scanned is stored and adjacent strip images are assembled to produce a final image of the entire specimen. Adjacent strips may be assembled by butting them together, or by collecting overlapping strip images and using feature-matching software for registration. FIG. 4A shows a slide scanner for transmission imaging that is a first embodiment of this invention. A tissue specimen 100 (or other specimen to be imaged) is mounted on microscope slide 101 (or other sample holder) on a scanning stage 105. For transmission imaging, the specimen is illuminated from below by light source 110. Microscope objective 400 (or other imaging objective) focuses light from the specimen on two-dimensional detector array 410, which is tilted with respect to the plane of the microscope slide about an axis that is parallel to the plane of the microscope slide and is perpendicular to the direction of stage motion, and is parallel to the rows of pixels along the long dimension of the array. When focused by lens 400, light from tilted object plane 450 in specimen 100 is collected by detector pixels in image plane 420. Light from the top of specimen 100 at position 421 will be focused on a pixel in the row of pixels at position 422 on image plane 420, and light from the bottom of the specimen at position 423 will be focused on a pixel at position 424 on image plane 420. Each row of pixels in detector 410 (rows pointing into the paper in this figure) collects data from a different depth inside specimen 100. As stage 105 moves microscope slide 101 to the left, the array detector 410 is triggered to collect a series of image frames of a tilted object plane 450 as it moves through the specimen, triggering each time the stage has moved the specimen a distance that is equivalent to the distance between pixels in each plane of the final 3D digital image stack (see FIG. 11). For example, if the final image pixels represent points in the specimen spaced one micron apart, then the detector 410 is triggered whenever the stage has moved a distance equal to one micron. These images are stored in a computer (frame grabbers and the instrument computer are shown in FIG. 8) and finally assembled into a stack of image planes starting at the top of specimen 100 and continuing down into the specimen. Each row of pixels in detector 410 acts like the linear array in the scanner described in FIG. 1, but here each row of detector pixels acquires a series of rows of image pixels that make up an image from one plane inside the specimen. For large specimens, a 3D image of the entire specimen is collected by moving the microscope slide at constant speed using motorized stage 105 in a direction perpendicular to the tilt axis of detector array 410, resulting in collection of a digital 3D image stack of one strip of the specimen. Adjacent strips are then scanned and the 3D stack images of all strips are combined to assemble a 3D image of the entire specimen, comprised of a stack of two-dimensional images.

In FIG. 4A, dashed line 430 is the optical axis of the instrument. Dashed line 425 is an extension of image plane 420; dashed line 460 is an extension of the lens plane, and dashed line 455 is an extension of object plane 450. These three lines intersect at Scheimpflug line 440, a line perpendicular to the paper. This is the “Scheimpflug Rule”, which is well-known in view camera photography (e.g. see “Using the View Camera” by Steve Simmons, Revised edition 1992, Published by Amphoto, N.Y., page 47). Also see British Patent #1196, “Improved Method and Apparatus for the Systematic Alteration or Distortion of Plane Pictures and Images by means of Lenses and Mirrors for Photography and for other purposes” by Theodor Scheimpflug, 1904.

FIG. 4B shows a slide scanner like that in FIG. 4A, except a glass wedge 428 focuses light from object position 421 onto a detector pixel at 422, and light from object position 423 onto a detector pixel at 424, instead of onto virtual image positions at 426 and 427, which are on the same tilted image plane of the microscope as in FIG. 4A. Insertion of glass wedge 428 has tilted the object plane 450 even though detector 410 is perpendicular to the instrument axis 430. In some cases it may be appropriate to simply insert a glass wedge in front of the detector with the sharp angle of the wedge in the scan direction (or the opposite direction) instead of tilting the detector.

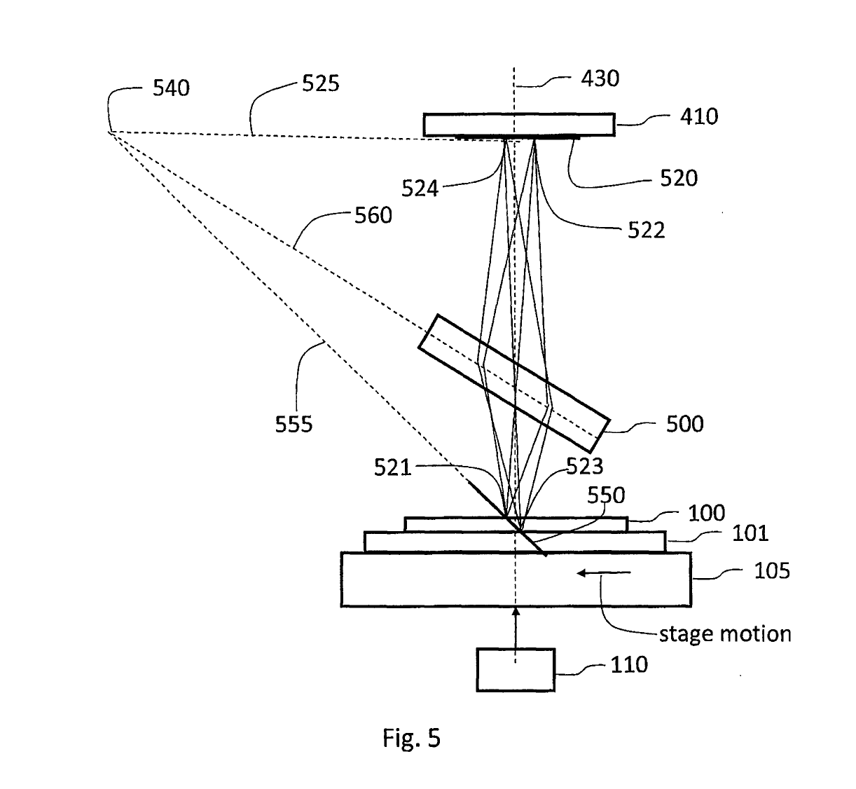

FIG. 5 shows a slide scanner for transmission imaging that is a second embodiment of this invention. A tissue specimen 100 (or other specimen to be imaged) is mounted on microscope slide 101 (or other sample holder) on a scanning stage 105. For transmission imaging, the specimen is illuminated from below by light source 110. Microscope objective 500 (or other imaging objective) is tilted with respect to the specimen 100 and focuses light from the specimen onto two-dimensional detector array 410, which is perpendicular to optical axis 430. When focused by lens 500, light from tilted object plane 550 in specimen 100 is collected by detector pixels in image frame 520. Light from the top of specimen 100 at position 521 will be focused on a pixel in the row of pixels at position 522 on image frame 520, and light from the bottom of the specimen at position 523 will be focused on a pixel at position 524 on image plane 520. Each row of pixels in detector 410 (rows pointing into the paper in this figure) collects data from a different depth inside specimen 100. As stage 105 moves microscope slide 101 to the left, the array detector 410 is triggered to collect a series of image frames of the tilted object plane 550 as it moves through the specimen. These image frames are stored in a computer (not shown in this diagram—see FIG. 8 which shows the frame grabbers and computer in an instrument with multiple detection arms) and finally assembled into a digital 3D stack of image planes starting at the top of specimen 100 and continuing down into the specimen. Each row of pixels in detector 410 acts like the linear array in the scanner described in FIG. 1, but here each row of detector pixels acquires a series of rows of image pixels that make up an image from one plane inside the specimen. The final result is a three-dimensional image of the specimen comprised of a stack of two-dimensional images. Note that in this embodiment the image circle of objective lens 500 must be large enough to include the area subtended by the detector pixels in two-dimensional detector array 410, which is not centered on the axis of imaging objective lens 500.

In FIG. 5, dashed line 430 is the optical axis of the instrument. Dashed line 525 is an extension of image plane 520; dashed line 560 is an extension of the lens plane, and dashed line 555 is an extension of object plane 550. These three lines intersect at Scheimpflug line 540, a line perpendicular to the paper, just as they did in FIG. 4. When the optical system is comprised of an infinity-corrected objective and tube lens, only the infinity-corrected objective must be tilted to achieve the same effect as the arrangement shown in FIG. 5.

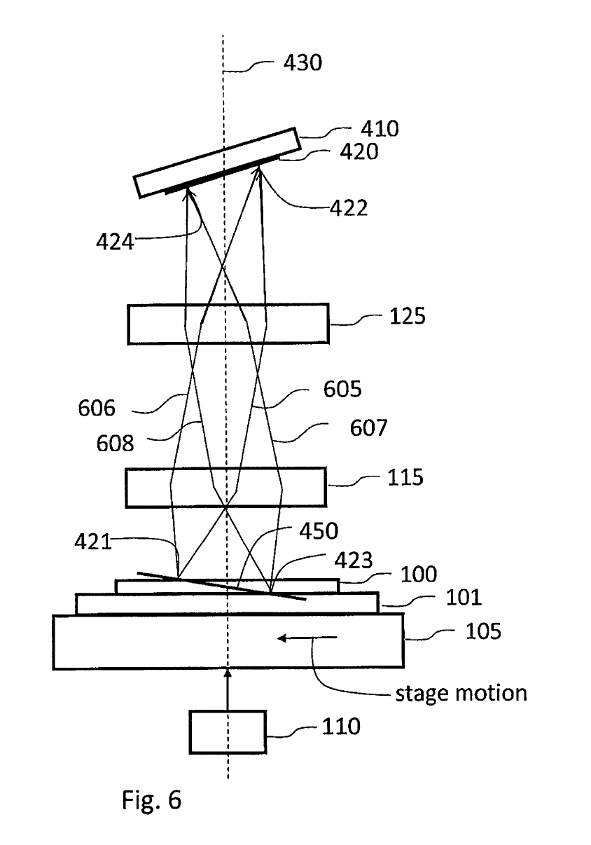

FIG. 6 shows a slide scanner for transmission imaging that is a third embodiment of this invention (a preferred embodiment). A tissue specimen 100 (or other specimen to be imaged) is mounted on microscope slide 101 (or other sample holder) on a scanning stage 105. For transmission imaging, the specimen is illuminated from below by light source 110. A combination of infinity-corrected microscope objective 115 (or other infinity-corrected imaging objective) and tube lens 125 focuses light from the specimen onto two-dimensional detector array 410, which is tilted with respect to the plane of the microscope slide about an axis that is in the plane of the microscope slide and is perpendicular to the direction of stage motion. When focused by objective 115 and tube lens 125, light from tilted object plane 450 in specimen 100 is collected by detector pixels in image plane 420. Light from the top of specimen 100 at position 421 will be focused to a parallel beam by objective 115 (the outside of this parallel beam depicted by rays 605 and 606) and focused by tube lens 125 onto a pixel in the row of pixels at position 422 on image plane 420, and light from the bottom of the specimen at position 423 will be focused by objective 115 to a parallel beam represented by rays 607 and 608 and then focused by tube lens 125 onto a pixel at position 424 on image plane 420. Each row of pixels in detector 410 (rows pointing into the paper in this figure) collects data from a different depth inside specimen 100. As stage 105 moves microscope slide 101 to the left, the array detector 410 is triggered to collect a series of image frames of the tilted object plane 450 as it moves through the specimen. These image frames are stored in a computer (as shown in FIG. 8) and finally assembled into a stack of digital 3D image planes starting at the top of specimen 100 and continuing down into the specimen. Each row of pixels in detector 410 acts like the linear array in the scanner described in FIG. 1, but here each row of detector pixels acquires a series of rows of image pixels that make up an image from one plane inside the specimen. The final result is a three-dimensional image of the specimen comprised of a stack of two-dimensional images, each image in the stack coming from a different row of pixels in the detector.

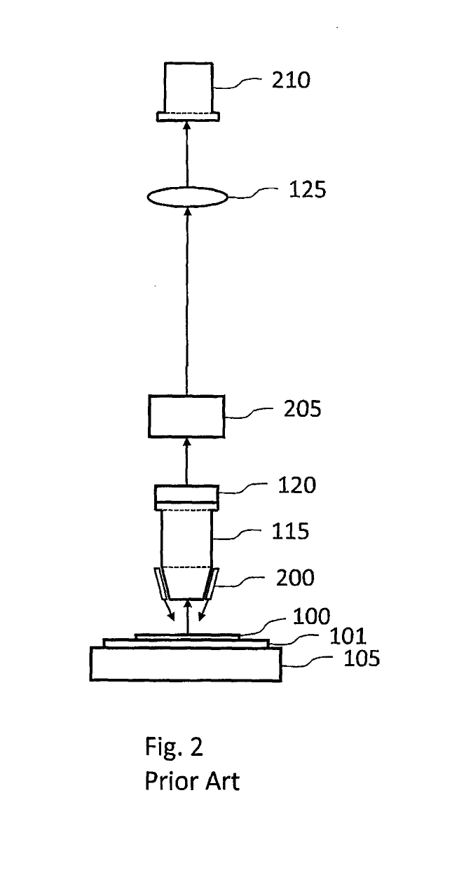

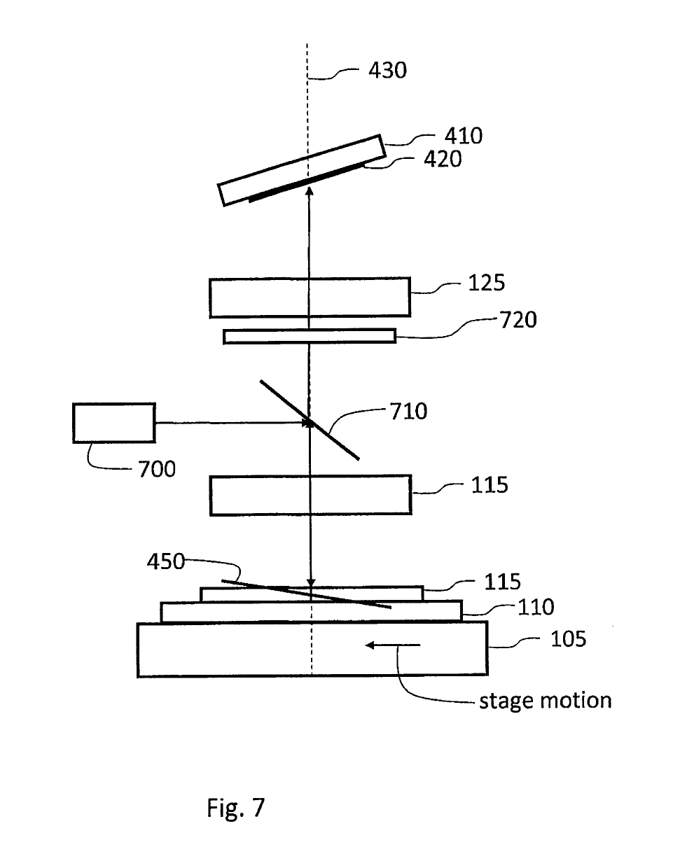

FIG. 7 shows a slide scanner for reflection or fluorescence imaging that is a fourth embodiment (the second preferred embodiment) of the instrument. This diagram is similar to FIG. 6, except that transmission light source 110 has been replaced by fluorescence (or reflected light) illumination source 700. When used for fluorescence imaging, the tissue specimen is illuminated from above by illumination source 700, mounted above the specimen (epifluorescence) so that the intense illumination light that passes through the specimen is not mixed with the weaker fluorescence emission from the specimen, as it would be if the fluorescence illumination source were below the specimen. Several different optical combinations can be used for epifluorescence illumination—light from a source mounted on the microscope objective, as shown in FIG. 2; illumination light that is injected into the microscope tube between the microscope objective and the tube lens, as shown in FIG. 7, imaged onto the back aperture of the objective, using a dichroic beamsplitter 710 to reflect it down through the microscope objective and onto the specimen; and several others. A narrow wavelength band for the illumination light is chosen to match the absorption peak of the fluorophore in use. This narrow-band illumination may come from a filtered white-light source, an LED or laser-based source (including a laser sent through a diffuser plate in rapid motion to eliminate speckle), or other source.

Fluorescence emitted by the specimen is collected by infinity-corrected microscope objective 115 (or other high-numerical-aperture objective lens). Emission filter 720 is chosen to reject light at the illumination wavelength and to pass the emission band of the fluorophore in use. For multi-spectral fluorescence imaging, Emission filter 720 can be replaced by a tunable filter. The tunable filter can be set to transmit a band of emission wavelengths from one fluorophore (or other fluorescent source) and a strip image stack recorded for that source, followed by setting a second wavelength band for a second fluorophore to record a strip image stack for that source, and so on until a strip image stack has been recorded for each fluorescence source in the specimen. The strip image stacks can either be viewed separately or combined into a single 3D image (usually false coloured) and the strips can then be assembled into a single 3D image of the entire specimen. Emission filter 720 can be removed from the optical system when the instrument is used for reflected-light imaging.

The microscope objective 115 and tube lens 125 form a real image of the specimen on tilted two-dimensional detector array 410. A 3D image of the specimen is collected by moving the microscope slide at constant speed using motorized stage 105 in a direction perpendicular to the tilt axis of detector array 410. As stage 105 moves microscope slide 101 to the left, the array detector 410 is triggered to collect a series of image frames of the tilted object plane 450 as it moves through the specimen, acquiring an image frame from the tilted detector array whenever the stage has moved a distance equivalent to the distance between pixels in each plane of the final 3D digital image stack. When used for brightfield imaging, a transmitted-light illumination source (110 as shown in FIG. 6) is used instead of illumination source 700 (which illuminates the specimen from above) and emission filter 720 and dichroic filter 710 are removed from the optical train.

FIG. 8 shows a fifth embodiment of the instrument, a slide scanner for fluorescence or brightfield imaging containing three separate detection arms for detecting three different fluorophores simultaneously or for detecting RGB brightfield images. (A scanner using a different number of detection arms can also be envisioned for other numbers of fluorophores). In particular, if quantum dots (nanocrystals) are used as a contrast agent in fluorescence, several detection arms can be used. This is possible because quantum dots can be manufactured with very narrow emission bands, and they are inherently brighter and more stable than fluorophores. In addition, all quantum dots in a specimen can be excited with the same excitation wavelength, so a single wavelength source can be used which is not in the emission bands of any of the dots in the specimen, making it easier to separate the emission signals.

When used for fluorescence imaging, a tissue specimen 100 (or other specimen to be imaged) which has been stained with three different fluorescent dyes is mounted on microscope slide 101 on a scanning stage 105. The tissue specimen is illuminated from above by illumination source 200, mounted above the specimen (epifluorescence) so that the intense illumination light that passes through the specimen is not mixed with the weaker fluorescence emission from the specimen, as it would be if the illumination source were below the specimen. Several different optical combinations can be used for epifluorescence illumination—light from a source mounted on the microscope objective, as shown; converging illumination light that is injected into the microscope tube between the microscope objective and the first dichroic mirror (830 in this diagram) that focuses on the back aperture of the objective, using a dichroic beamsplitter to reflect it down through the microscope objective and onto the specimen; and several others. Narrow wavelength bands are chosen for the illumination light to match the absorption peaks of the fluorophores in use. This narrow-band illumination may come from a filtered white-light source, an LED or laser-based source (including an amplitude or frequency-modulated laser or LED source), or other source. Fluorescence emitted by the specimen is collected by infinity-corrected microscope objective 115. Dichroic mirror 830 is chosen to reflect light in the emission band of the first fluorophore towards tube lens 810 placed in front of two-dimensional detector array 820. Microscope objective 115 and tube lens 810 form a real image of the tilted specimen plane 450 on tilted two-dimensional detector array 820. Data from the two-dimensional detector array is collected by frame grabber 870 or other electronic frame capture device and passed to computer 895. A detection arm comprises a dichroic mirror, tube lens, detector array and the associated frame grabber electronics. In some cases, a fluorescence emission filter is placed between the dichroic mirror and the detector, usually in the space between the dichroic mirror and the tube lens.

Light from the specimen 100 that was not reflected by dichroic mirror 830 continues up the microscope to reach dichroic mirror 840, which is chosen to reflect light in the emission band of the second fluorophore towards tube lens 850 placed in front of two-dimensional detector array 860. The microscope objective 115 and tube lens 850 form a real image of the tilted specimen plane 450 on two-dimensional detector array 860. Data from this two-dimensional detector array is read out by frame grabber 880 or other electronic frame capture device and passed to computer 895.

Light from the specimen 100 that was not reflected by dichroic minors 830 and 840 contains light in the emission band wavelengths for fluorophore three, and continues up the microscope to reach tube lens 125, in front of two-dimensional detector array 410. The microscope objective 115 and tube lens 125 form a real image of the tilted specimen plane 450 on tilted two-dimensional detector array 410. Data from this two-dimensional detector array is read out by frame grabber 890 or other electronic frame capture device and passed to computer 895. Computer 895 controls stage motion and data collection, as well as combining the image frames from each detector into a single digital 3D image stack of the data from that detector. When the specimen is too large to be imaged in a single scan, the 3D image stacks from each stage scan are combined into a single 3D image of the entire specimen.

When used for brightfield imaging, white light source 110 is used to illuminate the specimen from below (instead of using light source 200), and the dichroic minors 830 and 840 are chosen to separate the colours detected by area detectors 820, 860 and 410 into red, green and blue. Images from each of the three detection arms are combined to produce a 3D colour brightfield image stack. If area detector 410 is replaced by an RGB detector, dichroic minors 830 and 840 can be removed from the optical train and the single colour detector will produce a colour brightfield image.

Instead of using three detection arms, as shown in FIG. 8, it is also possible to use a trichroic prism to separate light emitted from three fluorophores to be focused on three CCD detectors. In this case a glass wedge can be placed in front of each detector where it is mounted on the dichroic prism to tilt the image plane. Such an assembly can also be used for 3D RGB brightfield imaging.

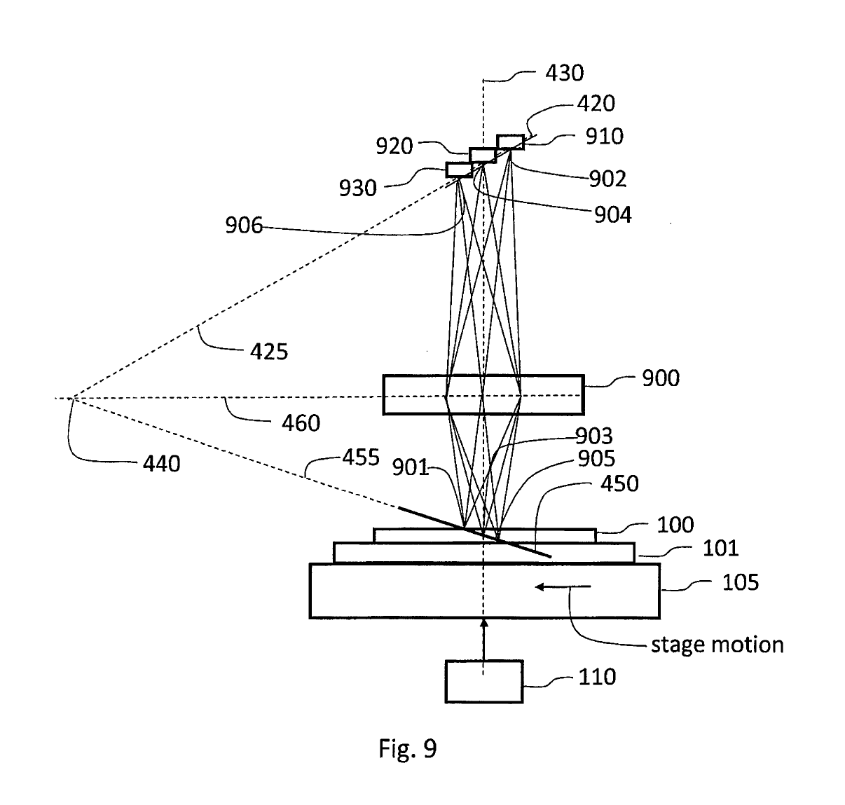

FIG. 9 shows a sixth embodiment of the instrument for brightfield imaging in which multiple linear array detectors are located on a tilted image plane (but each detector is mounted parallel to the scan plane, with its long dimension perpendicular to the scan direction). A tissue specimen 100 (or other specimen to be imaged) is mounted on microscope slide 101 (or other sample holder) on scanning stage 105. For transmission imaging, the specimen is illuminated from below by light source 110. In this diagram, focusing objective 900 represents either a microscope objective (or other non-infinity-corrected objective) or the combination of an infinity-corrected microscope objective and a tube lens. In either case, objective 900 focuses light from the specimen onto three linear detector arrays 910, 920 and 930, which are located on a plane tilted with respect to the plane of the microscope slide about an axis that is in the plane of the microscope slide and is perpendicular to the direction of stage motion. If more than three planes are desired in the final image, additional linear arrays can be located on the tilted image plane. The individual linear arrays are not tilted with respect to the scan plane, and are shown in this diagram with the line of pixels in the arrays perpendicular to the plane of the paper. When focused by lens 900, light from tilted object plane 450 in specimen 100 is collected by detector pixels in image plane 420. Light from a position near the top of specimen 100 at position 901 will be focused on a pixel in the row of pixels in detector 910 at position 902 on image plane 420, and light from a position near the bottom of the specimen at position 905 will be focused on a pixel in the row of pixels in detector 930 at position 906 on image plane 420. Light from a position near the middle of specimen 100 at position 903 will be focused on a pixel in the row of pixels in detector 920 at position 904 on image plane 420. The row of pixels in each detector 910, 920 and 930 (rows pointing into the paper in this figure) collects data from a different depth inside specimen 100. As stage 105 moves microscope slide 101 to the left, the three linear array detectors are triggered such that each collects an image at a different depth inside the specimen, triggering each time the specimen has moved a distance equivalent to the distance between pixels in each plane of the digital 3D image stack. For example, if each plane in the 3D image stack has pixels representing positions spaced 1 micron apart in the specimen, then the detectors 910, 920 and 930 are triggered whenever the stage has moved a distance equal to one micron. These images are stored in a computer (frame grabbers and the instrument computer are shown in FIG. 8) and finally assembled into a stack of three image planes starting near the top of specimen 100 and continuing down into the specimen. Here the row of pixels in each detector acquires a series of rows of image pixels that make up an image from one plane inside the specimen. In FIG. 9, dashed line 430 is the optical axis of the instrument. Dashed line 425 is an extension of image plane 420; dashed line 460 is an extension of the lens plane, and dashed line 455 is an extension of object plane 450. These three lines intersect at the Scheimpflug line 440, as described previously.

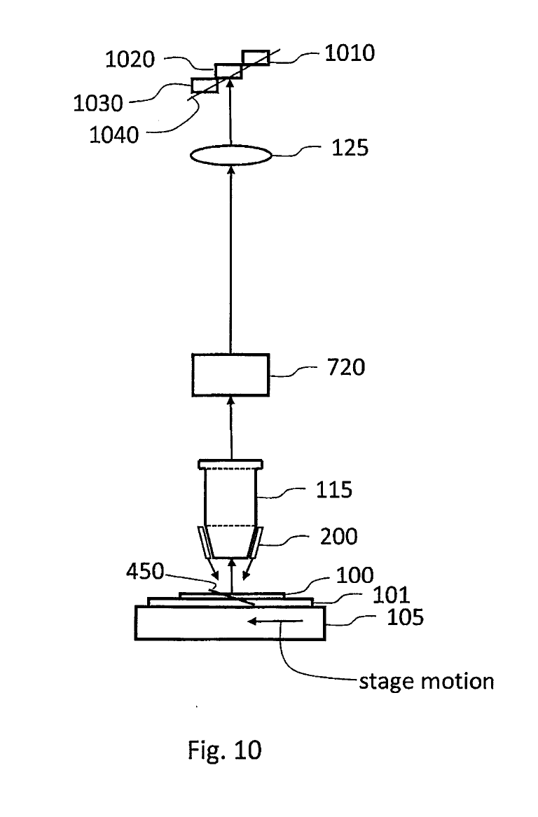

FIG. 10 shows a seventh embodiment of the present invention, a fluorescence scanner using multiple 2D detector arrays (TDI arrays, or 2D detector arrays for MSIA imaging) located on the tilted image plane (but with each detector array oriented in a plane parallel to the scan plane, with the rows of pixels along the long dimension of the array perpendicular to the plane of the paper). In this case, each detector array collects data from a single plane inside the specimen which is parallel to the scan plane. A tissue specimen 100 (or other specimen to be imaged) is mounted on microscope slide 101 on a scanning stage 105. The tissue specimen is illuminated from above by illumination source 200, mounted above the specimen (epifluorescence) so that the intense illumination light that passes through the specimen is not mixed with the weaker fluorescence emission from the specimen, as it would be if the illumination source were below the specimen. Several different optical combinations can be used for epifluorescence illumination—light from a source mounted on the microscope objective, as shown; converging illumination light that is injected into the microscope tube between the microscope objective and the emission filter that focuses on the back aperture of the objective, using a dichroic beamsplitter to reflect it down through the microscope objective and onto the specimen; and several others. Narrow wavelength bands are chosen for the illumination light to match the absorption peak of the fluorophore in use. This narrow-band illumination may come from a filtered white-light source, an LED or laser-based source (including an amplitude or frequency-modulated laser or LED source), or other source. Fluorescence emitted by the specimen is collected by infinity-corrected microscope objective 115 (or other high-numerical-aperture objective lens). Emission filter 720 is chosen to reject light at the illumination wavelength and to pass the emission band of the fluorophore in use. For multi-spectral fluorescence imaging, emission filter 720 can be replaced by a tunable filter. The tunable filter can be set to transmit a band of emission wavelengths from one fluorophore (or other fluorescent source) and a strip image stack recorded for that source, followed by setting a second wavelength band for a second fluorophore to record a strip image stack for that source, and so on until a strip image stack has been recorded for each fluorescence source in the specimen. Emission filter 720 can be removed from the optical system when the instrument is used for reflected-light imaging.

The microscope objective 115 and tube lens 125 form real images of the specimen on two-dimensional detector arrays 1010, 1020, and 1030, but each of these images comes from a different depth inside specimen 100. An image of the specimen is collected by moving the microscope slide at constant speed using motorized stage 105 in a direction perpendicular to the long dimension of detector arrays 1010, 1020 and 1030.

If these three detectors are TDI arrays, each of the three images is acquired one line at-a-time, as described earlier in this patent document.

If the three detectors are 2D arrays, Moving Specimen Image Averaging can be used to acquire a sequence of equally-spaced overlapping two-dimensional images from each array (usually spaced one line apart), thereby constructing three time-integrated images of the specimen at different depths. This technique is called Moving Specimen Image Averaging, as described earlier in this document.

FIG. 11 illustrates how a digital 3D image stack is produced by a single scan using the instruments shown in FIGS. 4, 5, 6, and 7. This figure shows part of a specimen and microscope slide at the bottom, and at the top the 3D image stack of the portion of the specimen between object planes 1140 and 1141 resulting from a single scan. Specimen holder 1110 supports specimen 1120 which is covered by cover slip 1125 (only the portions of the specimen holder, specimen and cover slip required to illustrate a single scan through the specimen is shown). The bottom part of the figure shows a series of tilted object planes 1130 that are imaged as the specimen moves in the scan plane. An image of each plane is acquired and recorded each time the moving specimen has moved a distance in object space that is equivalent to the distance between pixels in the horizontal image planes in the 3D image stack 1150. For illustration, the positions of pixels on tilted object plane 1160 are shown at the instant when the image of that plane is acquired. Data from that image are stored as image frame 1170 inside 3D image stack 1150. Note that image frames detected by tilted detectors (for example tilted detector 410 in FIG. 4A), must be rotated 180 degrees relative to the optical axis of the instrument before storage in the 3D image stack. As the scan proceeds, data from each image frame are rotated through 180 degrees and stored in sequence to produce the final 3D image. If the scan direction is from right to left in this diagram, then image frames are added to 3D image stack 1150 from left to right. In this example pixels in the image frames that were above the bottom of the cover glass or below the top of the microscope slide have been discarded so that the 3D image stack 1150 only contains planes inside the specimen. In addition, those pixels outside the boundaries of the specimen between planes 1140 and 1141 have been discarded, resulting in an image of only the part of specimen 1120 between planes 1140 and 1141. When the specimen is larger than that shown in this diagram, several scans may be required to image the entire specimen, and the 3D image stacks from each of these scans can be assembled to produce a single 3D image stack of the entire specimen.

When multiple tilted detectors are used, as shown in FIG. 8, each detector results in a 3D image stack. These image stacks can either be viewed separately, or they can be combined into a single 3D image stack. When each detector is used to detect a different color, for example in RGB brightfield imaging, the three image stacks can be combined into a single 3D RGB image stack. When multiple detectors are used for detecting several different fluorophores, a single false color image stack can be produced that can be useful for collocating different fluorophores.

When multiple detectors that are parallel to the scan plane are used, as shown in FIGS. 9 and 10 for example, data from each separate detector is stored in a single image plane in the 3D image stack. For example, if three detectors are used (as shown in the examples in FIGS. 9 and 10), the 3D image stack will contain only three image planes. As before, each exposure must be rotated through 180 degrees about the instrument axis before storage in the 3D image stack.

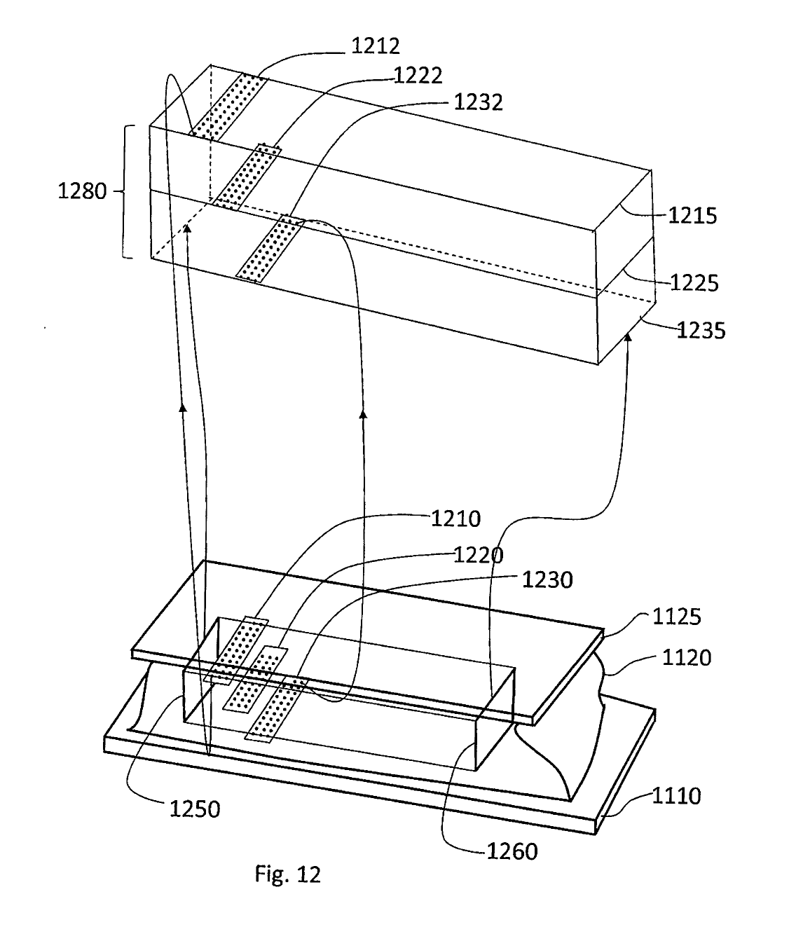

FIG. 12 illustrates how a three-layer digital image stack is produced by a single scan using the instruments shown in FIGS. 9 and 10. This figure shows part of a specimen, cover slip and microscope slide at the bottom, and at the top the three-layer image stack 1280 of the portion of the specimen between object planes 1250 and 1260 resulting from a single scan. Specimen holder 1110 supports specimen 1120 which is covered by cover slip 1125 (only the portions of the specimen holder, specimen and cover slip required to illustrate a single scan through the specimen is shown). The bottom part of the figure shows one set of object frames 1210, 1220 and 1230 that are imaged in series as the specimen moves at constant speed in the scan plane. An image of each object frame is acquired and recorded each time the moving specimen has moved a distance in object space that is equivalent to the distance between pixels in the horizontal image planes in the three-layer image stack 1280. For illustration, the pixel positions on the three object frames 1210, 1220, and 1230 are shown at the instant when the images of those frames are acquired. Data from those images are stored as image frames 1212, 1222 and 1232 in image planes 1215, 1225 and 1235 inside three-layer image stack 1280. Note that image frames detected by detectors placed on the tilted instrument image plane (but not themselves tilted with respect to the scan plane), for example detectors 910, 920 and 930 in FIG. 9, must be rotated 180 degrees relative to the optical axis of the instrument before storage in the three-layer image stack. As the scan proceeds, data from each image frame are rotated through 180 degrees and stored in sequence to produce the final 3D image. If the scan direction (the direction of motion of the specimen perpendicular to the optical axis of the instrument) is from right to left in this diagram, then image frames are added to three-layer image stack 1280 from left to right. Those pixels outside the boundaries of the specimen between planes 1250 and 1260 have been discarded, resulting in an image of only the part of specimen 1120 between planes 1250 and 1260. When the specimen is larger than that shown in this diagram, several scans may be required to image the entire specimen, and the three-layer image stacks from each of these scans can be assembled to produce a single three-layer image stack of the entire specimen. Note that three detectors are used in this example for illustrative purposes only. Any number of detectors can be used, where each detector results in one layer in the multi-layer image stack.

When each detector in the scanners shown in FIGS. 9 and 10 is a linear detector array (which contains only a single row of detector pixels), the object frames 1210, 1220, and 1230 shown in FIG. 12 will each be comprised of only a single row of pixels instead of the three rows shown in the figure, and the image frames 1212, 1222 and 1232 will also contain only one row instead of the three shown. As the scan proceeds, each detector records a single line image each time the specimen is moved a distance equal to the distance between rows of pixels in the image planes 1215, 1225 and 1235.

When each detector in the scanners shown in FIGS. 9 and 10 is a TDI detector array, which may contain many rows of detector pixels (only three are shown in FIG. 12 for illustrative purposes), the last row in each detector array (the row on the left in this figure) is read out each time the specimen has moved a distance equal to the distance between rows of pixels in the image planes 1215, 1225 and 1235, and stored as a single row in the three image planes (after rotation by 180 degrees about the instrument axis). In a TDI detector, the value of each pixel in the last row represents an integrated average of the light intensity from the same position in the object which was detected as the image of the object moved across the detector during scan.

When each detector in the scanners shown in FIGS. 9 and 10 is an ordinary two-dimensional detector array (not a TDI array), the entire array is read out each time the specimen has moved a distance equal to the distance between rows of pixels in the image planes 1215, 1225 and 1235. The image is rotated 180 degrees about the instrument axis and added to the existing image data in the three image planes 1215, 1225 and 1235, but each image frame is shifted one pixel position to the right before the data is added to the data already stored in the image store memory. Before starting the scan, all memory positions in the image store should be set to zero. For illustrative purposes, the detectors shown in FIG. 12 have only three rows of pixels, but the two-dimensional detector array may have many more rows. For example, a detector with 256 rows, each containing 4000 pixels, can be used, and in this case the final image will be an average of 256 exposures which increases the exposure time by a factor of 256 compared to the exposure time if a linear array were used at the same scan speed. This technique is called Moving Specimen Image Averaging (MSIA), as described earlier in this document, and is particularly important for imaging fluorescent specimens with weak fluorophores.

### ADVANTAGES AND USES OF THIS INVENTION

The slide scanner described in this patent document moves a tilted object plane through the specimen during scan, resulting in a stack of image planes at different depths in the specimen, which include planes inside the specimen but can also include planes above the specimen and planes below the specimen, if the specimen is thin (less than 50 microns thick if the specimen is tissue, for example). This results in a stack of two-dimensional images which constitute a three-dimensional image of the specimen. This is a first advantage of this invention.

Many tissue specimens mounted on microscope slides are less than 10 microns in thickness, and the prior-art scanners find it difficult to maintain focus during scan. The present invention can be set to automatically capture image planes above and below the specimen as well as planes inside the specimen, and a single, in-focus image plane can be assembled after scanning from in-focus areas of adjacent planes within the specimen, without requiring any mechanical focus adjustments during scan. This is a second advantage of this invention.

In addition to recording data that will be used to construct a three-dimensional image of the specimen, images of tilted object planes are also captured, and these tilted image planes can be analyzed to find the position of the surface of the microscope slide (at the bottom of the specimen) and the bottom of the cover slip (if one is used on the specimen) at the top of the specimen. When tilted in the direction shown in FIG. 4, and with direction of stage scan as shown, the position of the top of the microscope slide in the vertical or focus direction is detected before the top section of the specimen reaches the position where it will be imaged, and a mechanical focus adjustment can be performed to maintain focus relative to the top of the microscope slide during scan. This focus information can be fed back to a focus mechanism (like piezo positioner 120 shown in FIG. 1) to maintain focus during scan. When the direction of stage motion is in the opposite direction, the bottom of the cover slip (or the top of the specimen) can be detected before the plane being imaged inside the specimen reaches the imaging position, and this focus information can be fed back to a focus mechanism (like piezo positioner 120 shown in FIG. 1) to maintain focus during scan. This method is particularly useful when only a single plane inside the specimen will be detected and imaged (using one row in the tilted detector to acquire an image of the desired plane in the specimen). This is a third advantage of this invention.

Widefield deconvolution microscopy is used to increase the resolution of a widefield microscope. When viewing a specimen through a widefield microscope, the focal plane being viewed is contaminated with out-of-focus information from the adjacent specimen planes above and below the focal plane. Deconvolution is a computational method using 3D image stacks in which diffracted light is reassigned to its original location by deconvolving the microscope's point-spread function, producing higher resolution images. This technique is particularly useful in fluorescence. Widefield deconvolution microscopy may provide increased sensitivity and dynamic range when compared to confocal microscopy, another method of rejecting light from specimen planes above and below the focal plane (see “Deconvolution Microscopy” by Jean-Baptiste Sibarita, Adv Biochem Engin/Biotechnol (2005) 95: 201-243). When deconvolution microscopy is attempted with a prior-art infinity-corrected microscope, 3D image stacks are collected by moving the focal plane in the axial direction (with relative motion of the specimen and focal plane produced either by moving the microscope objective or the microscope slide). The three-dimensional image of the specimen produced by the slide scanner disclosed in this patent document can be used with computer-based deconvolution of the scanner's point spread function to provide increased resolution, sensitivity and dynamic range. Because it rapidly generates 3D image stacks of large specimens, this makes deconvolution microscopy of large specimens practical for the first time. This is a fourth advantage of this invention.

When viewing tissue through a widefield microscope, a pathologist often changes focus in the tissue by moving the microscope stage up and down relative to the microscope objective, allowing him to view specimen planes above and below the plane of interest. The same procedure will now be possible with the digital image when viewing the 3D image stack produced by the scanner disclosed in this patent document. This is a fifth advantage of this invention.

The 3D image stack produced by the scanner disclosed in this patent document can be viewed as a maximum-intensity projection image, and when combined with a companion file containing the depth information of the maximum-intensity pixels, a three-dimensional maximum intensity image can be produced. Such a maximum-intensity projection image is usually projected on a plane perpendicular to the optic axis of the instrument. This is a sixth advantage of this invention.

The 3D image stack produced by the scanner disclosed in this patent document can be viewed as a maximum-spatial-frequency projection image where the spatial frequency centered on each pixel in each image plane is calculated and the pixel value at the maximum is projected onto the projection plane (usually a plane perpendicular to the axis of the instrument). A companion file containing the depth information of the maximum-spatial-frequency pixels can be used with the projection image to produce a 3D image of the maximum spatial frequencies (where the spatial frequencies are measured in the same plane as the planes in the image stack, i.e. planes perpendicular to the optical axis of the instrument). This image will emphasize edges in the horizontal plane of the specimen. If the maximum-spatial-frequency projection images and companion pixel position files are calculated for the three perpendicular directions in the 3D image stack, a 3D image that emphasizes edges in the three perpendicular directions can be constructed. This is a seventh advantage of this invention.

The slide scanner disclosed in this patent document produces a 3D image stack of a large tissue specimen. Such a 3D image can be used with image processing algorithms to detect tissue morphology in three dimensions, which will be useful in computer-aided diagnosis of cancer, and for collocation of features in fluorescence and brightfield images. This is an eighth advantage of this invention.

Many other advantages and applications that depend on the features of the slide scanner described in this patent document will be obvious to those who are active in fluorescence and brightfield microscopy.

We claim:

1. An instrument for scanning a large specimen, the instrument comprising a specimen holder to support the specimen, an optical system to focus an image of a series of parallel object planes in the specimen onto a two dimensional detector array, the detector array having a detector image plane, the detector image plane being tilted relative to the series of object planes in a scan direction to enable a series of image frames of the specimen to be obtained during a scan as the specimen moves relative to an optical axis of the instrument in a scan plane, data from each row of the image frame representing a different plane in a three-dimensional image of at least part of the specimen comprised of a stack of image planes, the detector array being mounted to tilt about an axis that is parallel to rows of pixels in the detector array.

2. (canceled)

3. An instrument as claimed in claim 1 wherein the instrument is a scanner with an infinity-corrected objective and a tube lens, each object plane being optically tilted relative to the detector image plane by the detector array being tilted relative to the scan plane.

4. An instrument as claimed in claim 1 wherein data from each row of pixels in the detector array represents one plane of a three dimensional image of the specimen.

5. An instrument as claimed in claim 2 wherein data from each row of pixels in the detector array represents one plane of a three dimensional image of the specimen.

6. (canceled)

7. (canceled)

8. An instrument as claimed in claim 1 wherein the instrument is a scanner for reflection or fluorescence imaging, with an illumination source located to illuminate the specimen from above.

9. An instrument as claimed in claim 2 wherein the instrument is a scanner for reflection or fluorescence imaging, with an illumination source located to illuminate the specimen from above.

10. (canceled)

11. An instrument as claimed in claim 1 wherein the instrument is a scanner for reflection or fluorescence imaging with an illumination source located to illuminate the specimen from above and there is software that enables a user to produce a maximum-intensity fluorescence projection image of the specimen.

12. (canceled)

13. (cancelled)

14. (canceled)

15. (canceled)

16. (canceled)

17. An instrument as claimed in claim 1 wherein a stack of image planes can be obtained resulting in a three-dimensional image comprised of the stack of image planes with software that enables the user to produce three maximum-spatial-frequency projection images in each of the X, Y, Z image planes and the vertical direction is the Z direction.

18. An instrument as claimed in claim 1 wherein a stack of image planes can be obtained resulting in a three-dimensional image comprised of the stack of image planes with software that enables the user to apply pattern-recognition algorithms to the three-dimensional image stack to identify regions of interest for use in computer aided diagnosis.

19. An instrument for scanning a large specimen, the instrument comprising a specimen holder to support the specimen, the specimen having a series of parallel object planes, an optical system to focus an image from each object plane onto multiple linear arrays positioned on a detector image plane tilted in a scan direction such that data from each linear array comprises a different plane in a three-dimensional image of at least part of the specimen comprised of a stack of image planes, the multiple linear arrays not being tilted but being located on the image plane that is tilted relative to a scan plane and relative to the series of object planes in the specimen to enable a series of image frames of the specimen to be obtained during the scan as the specimen moves relative to an optical axis of the instrument in the scan plane.

20. (canceled)

21. (canceled)

22. (canceled)

23. (canceled)

24. A method for scanning a large specimen using an instrument having a specimen holder to support the specimen, the specimen having a series of parallel object planes, an optical system to focus an image from each object plane of the specimen onto a two-dimensional detector array, the detector array having a detector image plane, the specimen being movable relative to the optical system, the method comprising optically tilting the detector image plane relative to the series of object planes in a scan direction, taking a series of image frames of the specimen during the scan, the image frames being tilted relative to a scan plane, moving the specimen relative to an optical axis of the instrument in the scan plane during a scan, and assembling the image frames to form a three dimension image of at least part of the specimen.

25. (canceled)

26. (canceled)

27. (canceled)

28. (canceled)

29. A method as claimed in claim 9 including the steps of imaging a specimen in a series of planes at different depths in the specimen.

30. A method as claimed in claim 9 including the steps of having leading rows of detector pixels detect the height of a surface of the specimen holder and producing feedback to actuate a focus mechanism to maintain subsequent rows of the detector array focused at a fixed distance above a top of the specimen holder.

31. A method as claimed in claim 9 including the steps of acquiring a stack of image planes using the two dimensional detector array and using the image stack with computer-based deconvolution of a point spread function of a scanner to provide increased resolution.

32. A method as claimed in claim 9 including the steps of acquiring a stack of image planes using the two dimensional detector array, imaging a different plane in the specimen for each row of pixels in the detector array, producing a three dimensional image comprised of the stack of image planes.

33. (canceled)

34. (canceled)

35. (canceled)

36. (canceled)

37. A method for scanning a large specimen using an instrument having a specimen holder to support the specimen, the specimen having a series of parallel object planes, an optical system to focus an image from each object plane of the specimen onto multiple linear arrays positioned on a detector image plane tilted in a scan direction, the specimen being movable relative to the optical system, the method comprising positioning the multiple linear arrays on an image plane tilted in the scan direction such that each linear array images a different plane in the specimen resulting in a three dimensional image comprised of a stack of image planes.

38. (canceled)

39. A method for scanning a large specimen using an instrument having a specimen holder to support the specimen, the specimen having a series of parallel object planes that are parallel to the scan plane, an optical system to focus an image from each object plane of the specimen onto a plurality of two dimensional arrays, the method comprising placing the two dimensional arrays that are parallel to the scan plane on a tilted image plane and using moving specimen image averaging to image the plurality of planes resulting in a three dimensional image comprised of a stack of image planes of at least part of the specimen in fluorescence.

40. (canceled)
